(19) United States
(12) Patent Application Publication
(10) Pub. No.: US 2024/0281493 A1
(43) Pub. Date: Aug. 22, 2024

(54) LEARNING DEVICE, LEARNING METHOD, AND LEARNING PROGRAM

(71) Applicant: HITACHI, LTD., Tokyo (JP)

(72) Inventor: Takuma Shibahara, Tokyo (JP)

(73) Assignee: HITACHI, LTD., Tokyo (JP)

(21) Appl. No.: 18/438,162

(22) Filed: Feb. 9, 2024

(30) Foreign Application Priority Data
Feb. 17, 2023 (JP) 2023-023567

(51) Int. Cl. G06F 17/11

(52) U.S. Cl. CPC G06F 17/11

(57) ABSTRACT

A learning device, acquiring a Pareto solution set based on multiple indicators, inputs a first Pareto solution set with at least a non-Pareto solution until a first step indicating a time point of elapsed time, and a first state of the environment in the first step, selects an action in the first state by providing the environment with the first Pareto solution set and the first state, acquires a reward related to the multiple indicators in the first step, and a second state of the environment in a second step, calculates, based on a cumulative reward up to the first step and the first Pareto solution set, a contribution degree which is a cumulative increase amount of a hypervolume since the first step, and updates a second Pareto solution set in the second step by adding the cumulative reward to the first Pareto solution set based on the contribution degree.

### CLAIM OF PRIORITY

The present application claims priority from Japanese patent application No. 2023-023567 filed on Feb. 17, 2023, the content of which is hereby incorporated by reference into this application.

### BACKGROUND OF THE INVENTION

### 1. Field of the Invention

The present invention relates to a learning device, a learning method, and a learning program.

### 2. Description of Related Art

In a video game, a player competes against each other according to various indicators (for example, a score and a clearing time) such as points acquired when items are acquired or a clearing time. At this time, the player is required to perform an excellent operation according to a plurality of indicators. In the video game, a player or a character operated by an artificial intelligence (AI) is prepared as an opponent of a human player, and the AI is also required to have excellent game operation ability according to the plurality of indicators.

A technique of optimizing the plurality of indicators is generally called multiple objective optimization (MPO) and is also widely applied to fields other than games. For example, the technique has applications in medical practice to find a treatment procedure that balances conflicting indicators such as effects and side effects. In the present specification, the term “environment” refers to not only a video game for amusement, but also a computer program that is a simulation environment in which an action of performing an operation as time elapses is simulated and that provides a plurality of indicators with respect to a result associated with the action. The AI capable of MPO can compete with a person in various real-world environments from a game for amusement to a surgical simulator or the like, and can prompt the person to improve actions.

NPL 2 discloses deep sea treasure (DST) as an example of an episodic MPO technique.

NPL 3 discloses a Walking Fish Group based algorithm.

### CITATION LIST

### Non Patent Literature

NPL 1: Reymond, Mathieu, and Ann Nowé. “Pareto-DQN: Approximating the Pareto front in complex multi-objective decision problems.” Proceedings of the adaptive and learning agents workshop (ALA-19) at AAMAS. 2019.
NPL 2: Vamplew, Peter, et al. “Empirical evaluation methods for multiobjective reinforcement learning algorithms.” Machine learning 84.1 (2011): 51-80.
NPL 3: Lyndon While, Lucas Bradstreet, and Luigi Barone. A fast way of calculating exact hypervolumes. IEEE Transactions on Evolutionary Computation, 16(1): 86-95, 2012.
NPL 4: Dornheim, J.: gTLO: A Generalized and Non-linear Multi-Objective Deep Reinforcement Learning Approach, arXiv preprint arXiv: 2204.04988 (2022)

### SUMMARY OF THE INVENTION

NPL 1 (hereinafter, Pareto-DON may be referred to as PDQN) discloses an AI capable of operating an environment in which MPO is required. PDQN is an example in which a reinforcement learning method called Q-learning is utilized for multiple objective optimization. In NPL 1, when there are a plurality of indicators, the AI can learn a strategy to enable acquisition of a set of solutions (referred to as a Pareto solution) in which a value of any one of the indicators is not inferior to other solutions. In the field of reinforcement learning, a strategy is a value reference indicating which action A(t) should be selected in order to achieve a desired objective in a state S(t) at a certain time point t in an environment. Specifically, the strategy is expressed by a probability value π(A(t)|S(t)) containing the state S(t) and the action A(t) as a pair.

In a game in which a score acquired when an item is acquired (a value obtained when a treasure is obtained) and a time until the acquisition (a remaining fuel amount) compete with each other as illustrated in FIG. 2 of NPL 1, a result obtained by learning an operation method for balancing the score and the acquisition time is illustrated in FIG. 3. As an example of the Pareto solution in FIG. 2 of NPL 1, there is “score 5, remaining fuel amount 7”. The Pareto solution is obtained when a submarine finally reaches a treasure 5 in the shortest time. On the other hand, a solution such as “score 5, remaining fuel amount 5” indicates that an extra operation of one cell is performed, and thus is not a Pareto solution. That is, a Pareto solution set in FIG. 2 of NPL 1 is given as a pair of “a value of a treasure, and a remaining fuel amount when the value is obtained in the shortest time”. That is, coordinate values in a two-dimensional space defined by the two indicators are generated. According to Algorithm 1: PDQN in NPL 1, for example, when there are five indicators, a process of randomly acquiring values of certain four indicators from a real number space and optimizing one remaining indicator has been proposed (“sample points p from Rd-1”, where d is the number of indicators and R is a real number). With regard to a sampling method, in FIG. 1 (a), it is described that “By incorporating domain knowledge about the objective-space”, but no mention is made of an efficient sampling method when there is no domain knowledge for each indicator. Based on (d−1) indicator values acquired when there is no available domain knowledge, no guarantee is given that a Pareto solution set can be acquired as a whole for all of the d indicators by optimizing only a d-th indicator. An object of the invention is to acquire a Pareto solution based on a plurality of indicators.

A learning device according to one aspect of the invention disclosed in the present application is a learning device including a circuit configuration configured to learn a strategy in an environment in which an action of performing an operation as time elapses is simulated and in which a value in an indicator space defined by a plurality of indicators is given as a Pareto solution with respect to a result associated with the action. The plurality of indicators at least include an indicator related to the elapsed time and an indicator related to an execution result of the environment. The circuit configuration executes input processing of inputting a first Pareto solution set in which at least a non-Pareto solution remains when the environment is executed until a first step indicating a time point of the elapsed time, and a first state of the environment in the first step, selection processing of selecting an action in the first state from the environment by providing the environment with the first Pareto solution set and the first state, acquisition processing of acquiring a reward related to the plurality of indicators in the first step obtained as a result of the environment selecting the action, and a second state of the environment in a second step that is a step subsequent to the first step due to the environment taking the action, calculation processing of calculating, based on a cumulative reward which is a cumulative value of rewards up to the first step and the first Pareto solution set, a contribution degree which is a cumulative increase amount of a hypervolume since the first step obtained as the result of the environment selecting the action, and update processing of updating a second Pareto solution set in the second step by adding the cumulative reward to the first Pareto solution set as the Pareto solution based on the contribution degree.

According to a typical embodiment of the invention, a Pareto solution can be acquired based on a plurality of indicators. Problems, configurations, and effects other than those described above will be clarified by descriptions of the following embodiments.

### BRIEF DESCRIPTION OF THE DRAWINGS

FIG. 1 is a diagram illustrating an example of an episodic MPO technique;

FIG. 2 is a block diagram illustrating a hardware configuration example of a learning device;

FIG. 3 is a block diagram illustrating an example of a training data generation unit executed by the learning device;

FIG. 4 is a block diagram illustrating an example of a batch learning unit executed by the learning device;

FIG. 5 is a diagram illustrating an example of a GUI screen according to a first embodiment;

FIG. 6 is a flowchart illustrating an example of a detailed process procedure for training data generation and batch learning that are executed by the learning device according to the first embodiment;

FIG. 7 is a block diagram illustrating network configuration examples of a Q network and a Q* network;

FIG. 8 is a diagram illustrating a specific example of step S604;

FIG. 9 is a diagram illustrating a hypervolume;

FIG. 10 is a diagram illustrating a first example of a Pareto solution set in an output format;

FIG. 11 is a diagram illustrating a second example of the Pareto solution set in the output format;

FIG. 12 is a table illustrating experimental results according to the first embodiment;

FIG. 13 is a graph illustrating a transition of the hypervolume according to the first embodiment; and

FIG. 14 is a flowchart illustrating an example of a detailed process procedure for training data generation and batch learning that are executed by a learning device according to a second embodiment.

### DESCRIPTION OF EMBODIMENTS

### First Embodiment

Hereinafter, an example of a learning device according to a first embodiment will be described with reference to the accompanying drawings. First, for convenience of description of the first embodiment, a processing flow of an episodic MPO technique will be described using the DST disclosed in NPL 2.

### Episodic MPO Technique

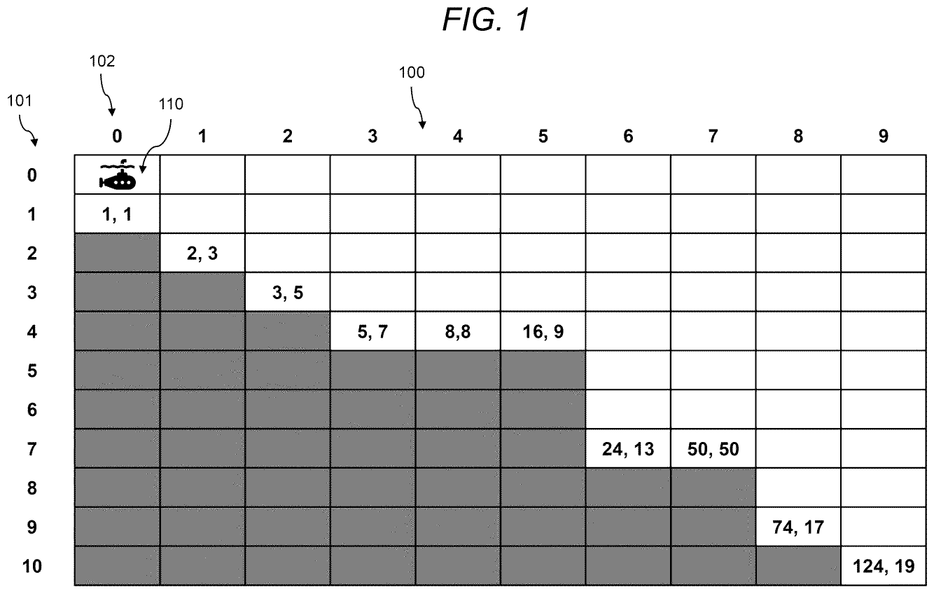

FIG. 1 is a diagram illustrating an example of an episodic MPO technique. The DST is an episodic MPO technique (game) executed by AI serving as an environment as disclosed in NPL 2. The DST includes a game screen 100 representing the vicinity of a seafloor in a matrix structure in which a plurality of rectangular cells are arranged in a matrix. On the game screen 100, a cell indicating a position of a submarine 110 on the game screen 100 is specified by a row number 101 and a column number 102.

On the game screen 100, gray cells indicate the seafloor, and white cells indicate seawater. A coordinate position of the submarine 110 is represented by a combination of a row number and a column number. In the present game, the submarine 110 is movable in four directions including upper, lower, left, and right directions.

To describe game contents of the DST, the submarine 110 waits at a coordinate position (0, 0) in an initial state of the game. The game screen 100 includes cells each having two sets of numerical values. Among the two sets of numerical values, a value on a left side is a score when a treasure is acquired, and a value on a right side is a minimum number of movement steps of the submarine 110.

For example, {124, 19} at a coordinate position (10, 9) indicates that the score is 124 and the minimum number of movement steps is 19, that is, the score of 124 is obtained by 19 times of operations of the submarine 110. When the submarine 110 moves once, a time corresponding to one step is consumed. When attempting to move the submarine 110 outside the game screen 100 or to a cell at the seafloor, the number of steps is added, and the submarine 110 remains at a current coordinate position. That is, the minimum number of movement steps indicates an action time due to a movement of the submarine 110.

When magnitude of the score and smallness of the number of steps indicating the action time due to the movement of the submarine 110 are used as indicators, a whole Pareto solution of the DST is {124, 19} indicating a cell at the coordinate position (10, 9). In the DST, the AI acquires the game screen 100 in a current state S, and operates the submarine 110 by selecting any of upward, downward, leftward, and rightward movements as an action A. Accordingly, the AI acquires {score, the minimum number of movement steps (action time)} indicating a reward R when the action A (any of upward, downward, leftward, and rightward movements) is executed in the state S (the state of the game screen 100) and a subsequent state S′ (a subsequent state of the game screen 100).

A combination of (S, A, R, S′) as information including such series of flows is training data of the AI. The AI according to the first embodiment, that is, the environment, learns a strategy for reaching points each corresponding to a Pareto solution. Although the first embodiment is described using the DST, the number of indicators is not limited as long as (S, A, R, S′) can be acquired in the environment, and the AI according to the first embodiment can learn the strategy for reaching points each corresponding to a Pareto solution.

### Hardware Configuration of Learning Device

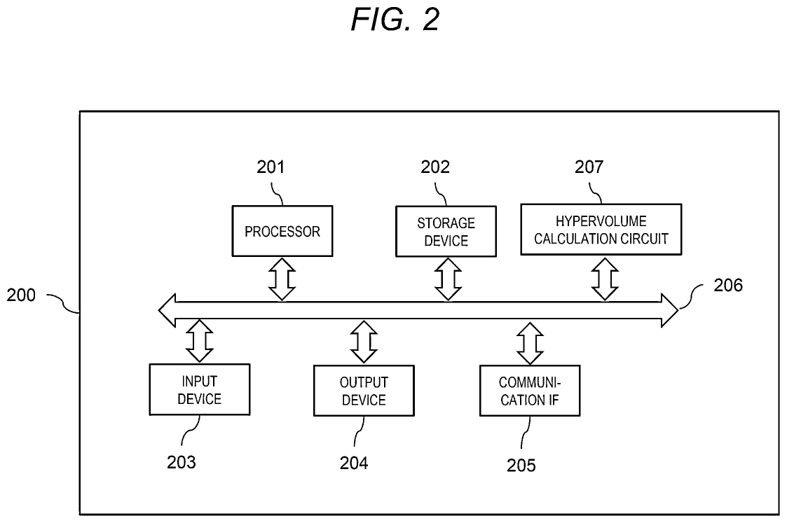

Next, a hardware configuration example of a learning device, on which the AI is mounted, illustrated in FIG. 2 will be described.

FIG. 2 is a block diagram illustrating the hardware configuration example of the learning device. A learning device 200 includes a processor 201, a storage device 202, an input device 203, an output device 204, and a communication interface (communication IF) 205. The processor 201, the storage device 202, the input device 203, the output device 204, and the communication IF 205 are connected by a bus 206. The processor 201 controls the learning device 200. The storage device 202 is a work area of the processor 201. The storage device 202 is a non-transitory or transitory recording medium that stores various programs or data. Examples of the storage device 202 include a read only memory (ROM), a random access memory (RAM), a hard disk drive (HDD), and a flash memory. The input device 203 inputs data. Examples of the input device 203 include a keyboard, a mouse, a touch panel, a numeric keypad, a scanner, a microphone, and a sensor. The output device 204 outputs data. Examples of the output device 204 include a display, a printer, and a speaker. The communication IF 205 is connected to a network to transmit and receive data.

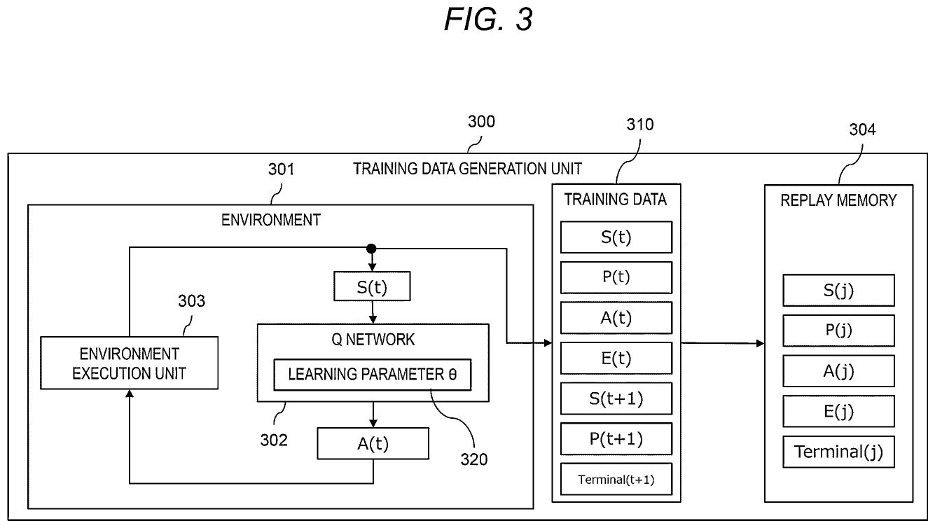

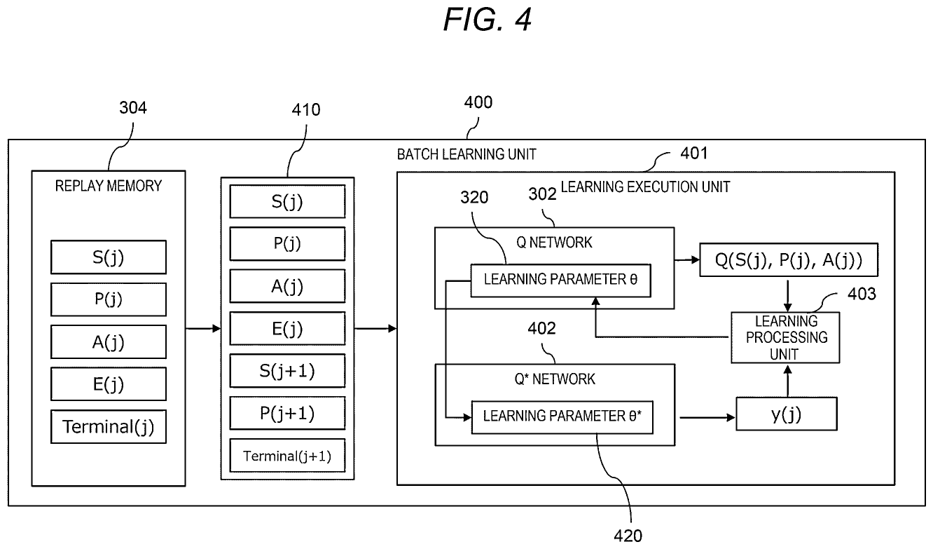

The learning device 200 may include a hypervolume calculation circuit 207. The hypervolume calculation circuit 207 has a circuit configuration functionally including a training data generation unit 300 (FIG. 3) and a batch learning unit 400 (FIG. 4) to be described later. The hypervolume calculation circuit 207 can execute PyGMO as open-source software. The training data generation unit 300 and the batch learning unit 400 may have a circuit configuration implemented by causing the processor 201 to execute a program stored in the storage device 202.

The learning device 200 learns a strategy that maximizes, by the hypervolume calculation circuit 207 (the training data generation unit 300 (FIG. 3) and the batch learning unit 400 (FIG. 4)), a volume (hypervolume) containing points formed by an executable strategy in an indicator space.

### Training Data Generation

FIG. 3 is a block diagram illustrating an example of the training data generation unit 300 executed by the learning device 200. The training data generation unit 300 includes an environment 301 and a replay memory 304. The environment 301 is a computer program that is a simulation environment in which an action of performing an operation as time elapses is simulated and that provides a plurality of indicators with respect to a result associated with the action. In this example, the environment 301 is an AI. Specifically, for example, the environment 301 includes a Q network 302 and an environment execution unit 303.

The Q network 302 is the AI described above. The Q network 302 outputs an action A(t) at step t in a state S(t) at step t using a learning parameter θ 320. Step t indicates the number of times of execution of the action A(t). Next, the environment execution unit 303 outputs a reward R(t) at step t for a result obtained by executing the action A(t), and a state S(t+1) of a subsequent step (t+1).

Here, the state S(t) is a coordinate position of the submarine 110 indicating a state of the game screen 100 at step t.

The action A(t) is a movement of the submarine 110 in a movement direction (any one of upper, lower, left, and right directions) selected at step t.

The reward R(t) is {score, the minimum number of movement steps (action time)} obtained as a result of executing the action A(t) at step t.

The state S(t+1) is a coordinate position of the submarine 110 indicating a state of the game screen 100 at step (t+1), that is, a coordinate position of the submarine 110 after being moved by the action A(t).

The Q network 302 and the learning parameter θ 320 are shared with the batch learning unit 400.

The environment execution unit 303 executes, for example, the DST described above. The environment execution unit 303 generates training data 310 each time the action A(t) is executed, and outputs the training data 310 to the Q network 302 and the replay memory 304.

The training data 310 generated by the environment execution unit 303 also includes Pareto solution sets P(t) and P(t+1), a contribution degree E(t), and a terminal signal T(t+1) in addition to the states S(t) and S(t+1) and the action A(t). The terminal signal T(t+1) indicates whether the execution by the environment execution unit 303 is ended.

The replay memory 304 stores a state S(j), an action A(j), a Pareto solution set P (j), a contribution degree E (j), and a terminal signal T(j+1) when a certain step t=j among the training data 310. The replay memory 304 is shared with the batch learning unit 400. j is a randomly selected step t.

### Batch Learning

FIG. 4 is a block diagram illustrating an example of the batch learning unit 400 executed by the learning device 200. The batch learning unit 400 includes the replay memory 304 and a learning execution unit 401. The learning execution unit 401 acquires the state S (j), the action A (j), the Pareto solution set P(j), the contribution degree E (j), and the terminal signal T(j+1), which form a batch 410, from the replay memory 304.

The learning execution unit 401 calculates a target value y(j) at step j. The learning execution unit 401 calculates the learning parameter θ 320 of the Q network 302 using a gradient method. The learning execution unit 401 copies the learning parameter θ 320 of the Q network 302 into a learning parameter θ* 420 of a Q* network 402 for each predetermined number of steps C (for example, C=5). The learning execution unit 401 displays a current search status of Pareto solutions on a display screen.

### Hypervolume Calculation Processing

Next, a detailed process procedure of hypervolume calculation processing executed by the learning device 200 according to the first embodiment will be described. Before the execution, a graphical user interface (GUI) screen is displayed on the output device 204.

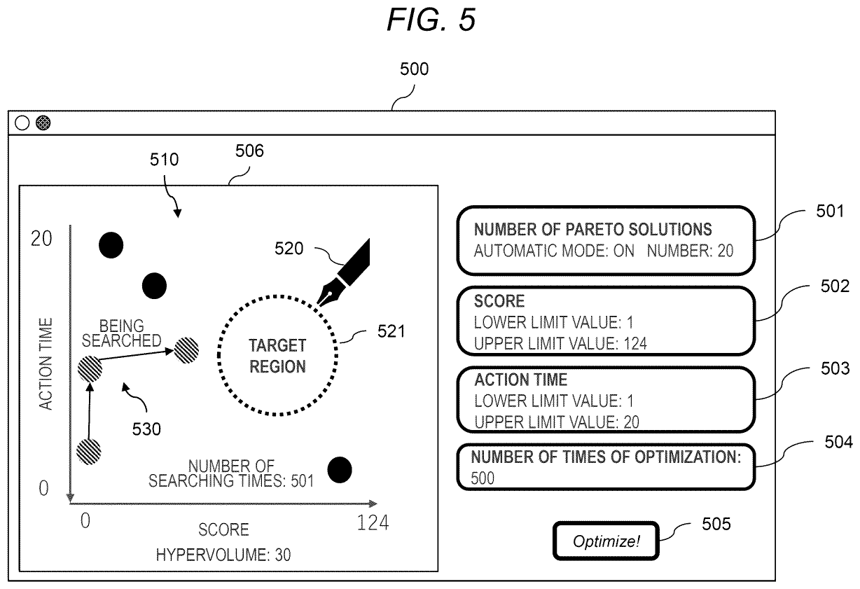

FIG. 5 is a diagram illustrating an example of a GUI screen according to the first embodiment. A GUI screen 500 includes a first setting region 501 to a fourth setting region 504, an execution start button 505, and a drawing region 506.

The first setting region 501 is a user interface capable of setting the number of Pareto solutions K by a user operation. The learning device 200 may also automatically set the number of Pareto solutions K (K=20 in the example of FIG. 5).

The second setting region 502 is a user interface capable of setting an upper limit value and a lower limit value that define a range of scores by a user operation. In FIG. 5, the lower limit value is set to “1” and the upper limit value is set to “124”.

The third setting region 503 is a user interface capable of setting an upper limit value and a lower limit value that define a range of action time by a user operation. In FIG. 5, the lower limit value is set to “1” and the upper limit value is set to “20”.

The fourth setting region 504 is a user interface capable of setting the number of times of optimization by a user operation. The number of times of optimization is the number of episodes M. In FIG. 5, the number of times of optimization is set to “500”.

The execution start button 505 is a user interface that starts, when being pressed by a user operation, execution of training data generation and batch learning that are executed by the hypervolume calculation circuit 207.

The drawing region 506 is a region in which searching states of Pareto solutions are drawn. Specifically, for example, an indicator space 510 is displayed in the drawing region 506. The indicator space 510 is a graph with the range of scores set in the second setting region 502 as a horizontal axis and the range of action time set in the third setting region 503 as a vertical axis. Black circles inside the indicator space 510 represent already-searched Pareto solutions, and hatched circles represent Pareto solutions being searched.

In the drawing region 506, a target region 521 of the Pareto solution can be set by a drawing tool 520 operated by a user. The learning device 200 may set a range of the horizontal axis corresponding to the target region 521 as the range of scores in the second setting region 502, and set a range of the vertical axis corresponding to the target region 521 as the range of action time in the third setting region 503. Accordingly, the user can intuitively set the target region 521 of the Pareto solution without inputting numerical values in the second setting region 502 and the third setting region 503.

The learning device 200 may draw arrows indicating a search order among the Pareto solutions being searched. Accordingly, the Pareto solutions being searched and a search status 530 of the Pareto solutions formed by the arrows are visualized.

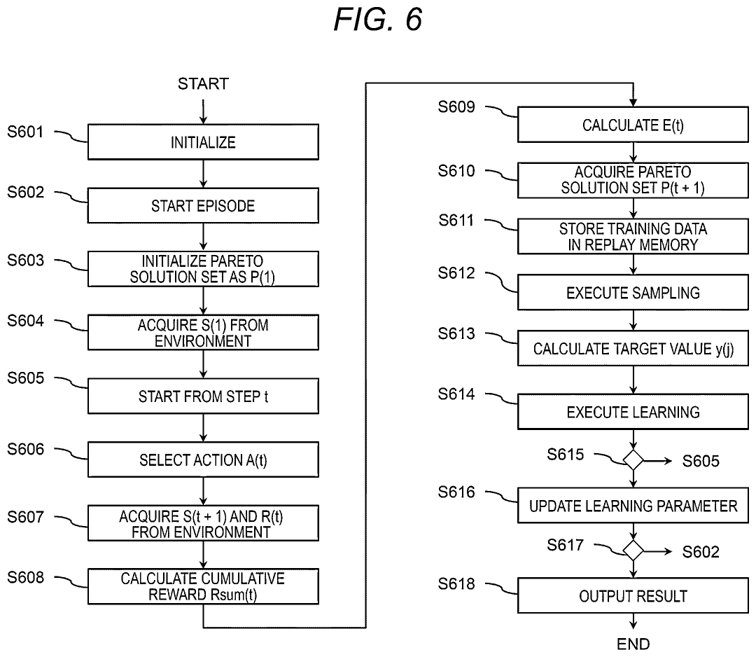

FIG. 6 is a flowchart illustrating an example of a detailed process procedure for training data generation and batch learning that are executed by the learning device 200 according to the first embodiment. When the execution start button 505 is pressed, the process illustrated in FIG. 6 is started.

### Step S601

The learning device 200 initializes the learning parameter θ 320 of the Q network 302 with a random value, and initializes the learning parameter θ* 420 of the Q* network 402 with a random value. The learning device 200 initializes the replay memory 304 with a capacity N (N=10,000 in the first embodiment). Here, configurations of the Q network 302 and the Q* network 402 will be specifically described.

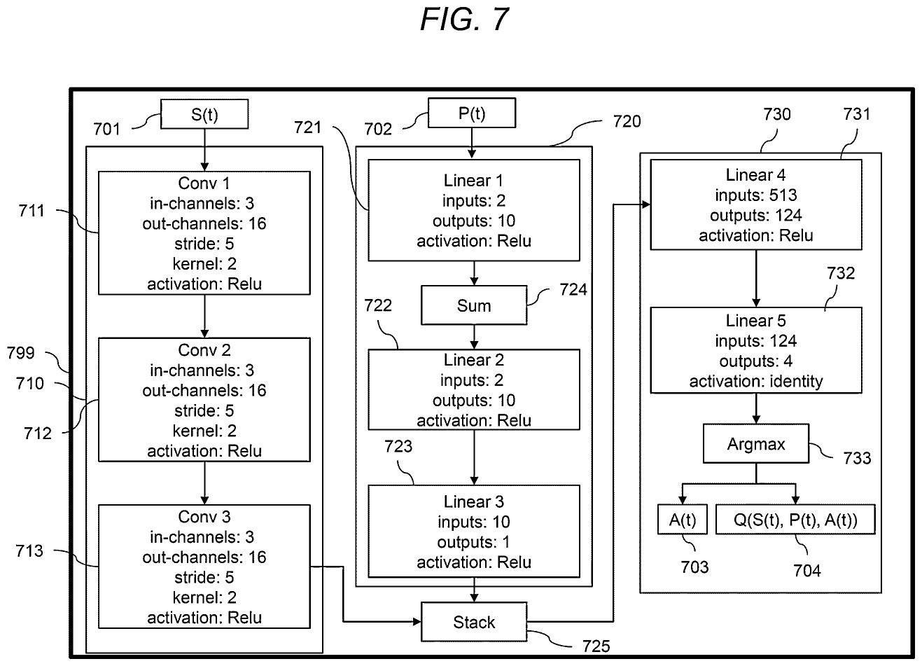

FIG. 7 is a block diagram illustrating network configuration examples of the Q network 302 and the Q* network 402. The Q network 302 and the Q* network 402 are networks 799 having the same configuration.

The Q network 302 and the Q* network 402 receive the state S(t) and the Pareto solution set P(t) as inputs 701 and 702, respectively, and output the action A(t) and a predicted value Q(S(t), P(t), A(t)) as outputs 703 and 704, respectively. Therefore, the Q network 302 and the Q* network 402 are set as a Q function 302 and a Q* function 402, respectively. Therefore, it is also possible to use a database in a table format in which the inputs 701 and 702 are set as element numbers and the outputs 703 and 704 are set as stored values.

In the first embodiment, it is described that a neural network 799 is used as a form of the Q function 302 and the Q* function 402. Alternatively, a non-linear function having the same expression ability as the neural network may be used.

The network 799 includes three blocks of a featured network 710, a set function network 720, and a value network 730. The featured network 710 is a neural network that executes processing of converting the state S(t) into a vector. The set function network 720 is a neural network that executes processing of converting the Pareto solution set P(t) into a vector. The value network 730 is a neural network that outputs the action A(t) in the Pareto solution set P(t).

The featured network 710 includes convolutional networks 711 to 713 (Conv 1 to Conv 3). In each of the convolutional networks 711 to 713, arguments include the number of input channels (in-channels), the number of output channels (out-channels), the number of strides (stride), a kernel size (kernel), and activation function an (activation) such as a Relu function or an identity function. The featured network 710 receives the state S(t) 701 and outputs a vector formed of real-number values by passing through the convolutional networks 711 to 713. In this embodiment, the number of dimensions of the vector output from the featured network 710 is 512 dimensions.

The set function network 720 includes linear networks 721 to 723 (Linear 1 to Linear 3). In each of the linear networks 721 to 723, arguments include the number of inputs (inputs), the number of outputs (outputs), and an activation function (activation) such as a Relu function or an Identity function.

The set function network 720 includes an add function 724 (Sum). Here, it is assumed that the number of indicators to be optimized is set as Y (Y is an integer of 1 or more), and values of the Y indicators are combined and set as a Y-dimensional vector to handle a reward. The linear network 721 receives a Y-dimensional vector (Y=2 in the first embodiment as an example) corresponding to the number of Pareto solutions K (elements). The add function 724 (Sum) is processing of adding values corresponding to the number of Pareto solutions K along dimensions so as to obtain one set×Y dimensions when the number of Pareto solutions K (elements)×Y dimensions are input.

Next, configuration requirements of the set function network 720 will be described. The set function network 720 includes one or more neural networks for each of input and output of the add function 724 (Sum). The set function network 720 receives the Pareto solution set P(t) 702 and outputs a vector formed of real-number values by passing through the linear network 721, the add function 724, and the linear networks 722 and 723. In this embodiment, the number of dimensions of the vector output from the set function network 720 is one dimension.

For example, as a minimum configuration of the set function network 720, the linear network 722 (Linear 2) may be omitted by directly connecting the output of the add function 724 to the linear network 723 (Linear 3).

By satisfying the configuration requirements of the set function network 720, the set function network 720 outputs the same value even when the Pareto solutions included in the Pareto solution set P(t) as the input 702 has a different order (that is, the value is regarded as the same value from the value network 730 at a subsequent stage).

For example, the set function network 720 outputs the same value (for example, 0.1) for each of a Pareto solution set {b(1), b(2), b(3)} and a Pareto solution set {b(3), b(2), b(1)}. When the input set has different number of elements, for example, even when K elements×Y dimensions are input, the set function network 720 outputs one number by reducing the add function 724 to a value of one set×Y dimensions. It is intuitively equivalent to assigning a unique number to a set. Therefore, the set function network 720 can transmit equivalence or mismatch of the set to the value network 730 at the subsequent stage.

A coupling function 725 (Stack) is a function that couples the 512-dimensional vector output from the convolutional network 713 (Conv 3) and the one-dimensional vector output from the linear network 723 (Linear 3) and converts the coupled vector into a 513-dimensional vector. Output of the coupling function 725 (Stack) forms input of the value network 730.

The value network 730 includes a linear network 731 (Linear 4) and a linear network 732 (Linear 5). The value network 730 includes a maximum value function 733 (Argmax), which is a function that outputs an index of a maximum value among four-dimensional output values from the linear network 732 (Linear 5) and sets the index as the action A(t).

In the first embodiment, it is assumed that a value of the action A(t) has a correspondence relationship in which one-dimension corresponds to upper, two-dimension corresponds to lower, three-dimension corresponds to left, and four-dimension corresponds to right. The maximum value function 733 (Argmax) outputs the predicted value Q (S(t), P(t), A(t)) of the linear network 732 (Linear 5) in the action A(t). The learning parameters θ 320 and θ* 420 are learning coefficients of neurons stored in the convolutional networks 711 to 713 (Conv 1 to Conv 3), and the linear networks 721 to 723, 731, and 732 (Linear 1 to Linear 5).

In the environment 301 other than the DST, the user can set the number of indicators to be optimized as the number of inputs (inputs) in the linear network 721 (Linear 1) (for example, when the number of indicators is 10, the inputs is 10). The user can also flexibly set a type of action, and simply set several minutes necessary for the number of outputs (outputs) in the linear network 732 (Linear 5) (for example, 109 or the like may correspond to all keys of a keyboard). Based on the above, when the environment 301 is an environment in which data can be obtained that includes the combination (S, A, R, S′), the number of indicators Y is not limited, and the AI (environment 301) according to the first embodiment can learn the strategy for reaching points each corresponding to a Pareto solution. In the first embodiment, the network 799 based on Q-learning is described for ease of description. A learning method in which a value function in reinforcement learning, a policy function, and the Q function 302 are provided with the set function network 720 can be easily inferred from the first embodiment. For example, a reinforcement learning model that handles a value function V(S(t)) (critic function) in the state S(t) such as Actor-Critic may be used. In this case, the value function is changed to V(S(t), P(t)), and the output of the linear network 732 (Linear 5) is set as the value function V (S(t), P(t)) (the outputs is set to be one-dimensional, and the Argmax 733 is omitted). In addition, a policy function π(S(t)) (actor function) is changed to π(S(t), P(t)), and the output of the linear network 732 (Linear 5) is set as the policy function n (S(t), P(t)) (the outputs is set to be four-dimensional, activation is set as a softmax function, and the maximum value function 733 (Argmax) is omitted). As described repeatedly, the network (function) to which the Pareto solution set P(t) is input is required to have a configuration capable of receiving the Pareto solution set P(t), that is, the set function network 720 is required to be held in the network 799.

Returning to FIG. 6, the learning device 200 repeats episodes from steps S602 to S617 for the number of times of optimization M set in the fourth setting region 504 of the GUI screen 500.

### Step S602

The learning device 200 starts an m-th episode. An initial value of m is m=1, and m is an integer satisfying 1≤m≤M.

### Step S603

For each episode corresponding to the number of Pareto solutions K set in the first setting region 501 of the GUI screen 500, or for the m-th episode, the learning device 200 adds a Nadir neighboring point b(0) as a non-Pareto solution to a Pareto solution set P(t=1). In the first embodiment, it is assumed that K=10 and b(0)=(0.1, 19.9).

### Step S604

The learning device 200 acquires a state S(t=1) from the environment execution unit 303 at a start time. Here, step S604 will be described using the game screen 100.

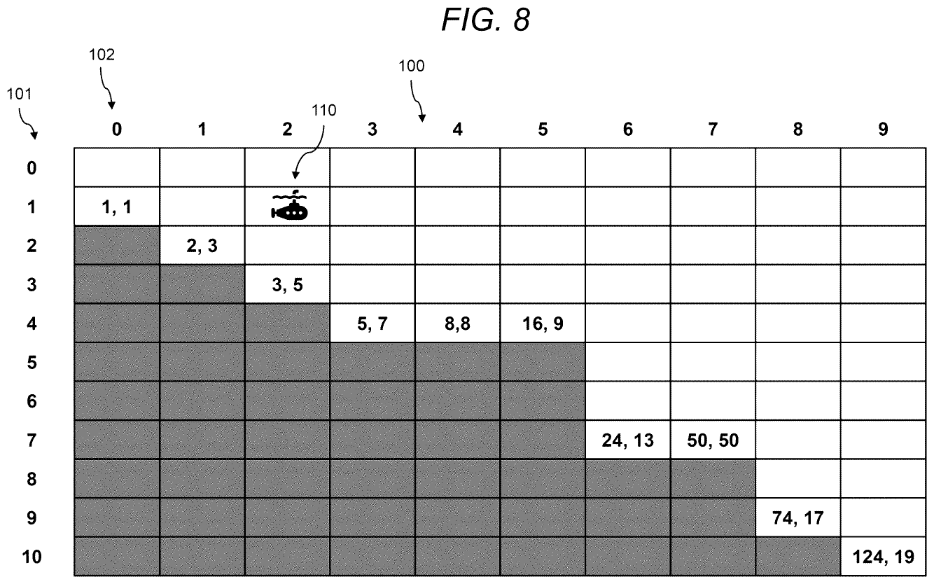

FIG. 8 is a diagram illustrating a specific example of step S604. The state S(t) is, for example, an image 600 containing 40×90 pixels and formed of 11×10 cells, and is the game screen 100 on which a coordinate position of the submarine 110 and the seafloor (gray cells) are drawn. In the DST, in the state S(t=1) at the start time, the coordinate position of the submarine 110 is (0, 0) as illustrated in FIG. 1.

### Step S605

The learning device 200 sets an initial value of step t as t=1, and repeatedly executes steps S605 to S615 T times (in this example, it is assumed that T=20). When the process returns from step S615 to step S605, step t is incremented.

### Step S606

The learning device 200 selects the action A(t) to be taken by the environment 301. Specifically, for example, when a predetermined condition, for example, a value of a random number obtained when a uniform random number equal to or greater than 0 and equal to or smaller than 1 is generated is equal to or greater than a, or when a current episode is the m-th episode, the learning device 200 obtains the action A(t) from the Q network 302 by providing the state S (t) and the Pareto solution set P(t) for the Q network 302. When the above predetermined condition is not satisfied, the learning device 200 randomly determines the action A(t).

### Step S607

The learning device 200 inputs the action A(t) to the environment execution unit 303, and acquires the reward R(t)={score, the minimum number of movement steps (action time)}, the state S(t+1) indicating the game screen 100 of the subsequent step (t+1), and a terminal signal Terminal (t+1). To describe the reward R(t)={score, the minimum number of movement steps (action time)} output from the environment execution unit 303, when the submarine 110 is at a position of a treasure, the score is a value (≠0) indicating the treasure, and when the submarine 110 is not at the position of the treasure, the score is 0. The minimum number of movement steps (action time) is increased by “−1” each time the reward R(t) is output from the environment execution unit 303.

When the position of the submarine 110 matches the position of the treasure, or when t>T, the environment execution unit 303 outputs a terminal signal Terminal(t+1)=1 (indicating an end), and when the position of the submarine 110 does not match the position of the treasure, the environment execution unit 303 outputs a terminal signal Terminal (t+1)=0.

### Step S608

The learning device 200 calculates a cumulative reward Rsum(t). The cumulative reward Rsum(t) is a real vector in which the number of elements is equal to the number of indicators Y. In the case of this example, since the indicators are the “score” and “the minimum number of movement steps (action time)”, the number of indicators Y is “2”. The learning device 200 calculates the cumulative reward Rsum (t) by the following Formula (1) using the reward R(t)={score, the minimum number of movement steps (action time)}.

$$Rsum ( t ) = {\sum }_{k = 1}^{t} R ( t ) \qquad ( 1 )$$

An addition using the above Formula (1) is executed for each indicator. For example, when R(t=1)=(0, −1), R(t=2)={0, −1}, and R(t=3)={2, −1}, the cumulative reward Rsum(t=2)=[2, −3].

### Step S609

The learning device 200 uses the cumulative reward Rsum (t) and the Pareto solution set P(t) and calculates the contribution degree E(t) using the following Formula (2).

$$E ( t ) = H ( - \{ \{ Rsum ( t ) \} ⋃ P ( t ) \} ) - H ( - P ( t ) ) \qquad ( 2 )$$

A function H on a right side of the above Formula (2) is a function for outputting a volume as a hypervolume, and for example, the Walking Fish Group based algorithm illustrated in NPL 3 is used.

For example, by using the open-source software PyGMO, the learning device 200 can simply and quickly calculate the contribution degree E(t) as an exclusive contribution when the cumulative reward Rsum(t) is added. A minus sign in “−P(t)” on the right side of the above Formula (2) indicates a calculation in which signs of coordinate values in the Pareto solution set P(t) are inverted. For example, −{(0, 1), (1, −2)} as a Pareto solution set P(t) has the same value as {(0, 1), (−1, 2)}. Here, a hypervolume when there are two indicators will be described.

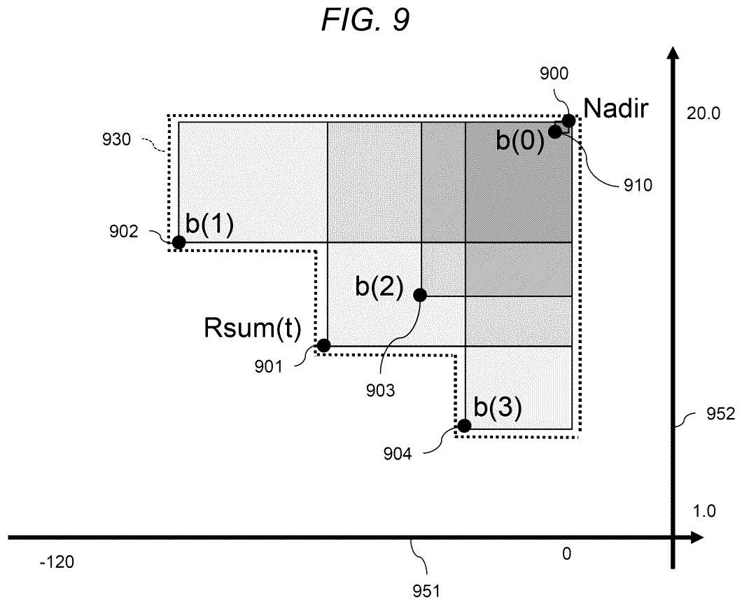

FIG. 9 is a diagram illustrating a hypervolume. In FIG. 9, a horizontal axis 951 indicates a score, and a vertical axis 952 indicates an action time. In FIG. 9, signs of the score and the action time are inverted. Points 901, 902, and 904 are Pareto solutions (hereinafter, may be referred to as Pareto solutions 901, 902, and 904). A point 910 is a Nadir neighboring point b(0) as a non-Pareto solution. The Nadir neighboring point b(0) is set in step S603. In FIG. 9, it is assumed that K=10 and b(0)=(0.1, 19.9).

A point 900 is Nadir (hereinafter, may be denoted by Nadir 900). The hypervolume in which the Pareto solutions are set as the points 901, 902, and 904 with reference to the Nadir 900 is an area 830 as a combined region (sum set) of a rectangular region with the Pareto solutions (points 901, 902, and 904) as diagonal points.

In the worst case of the DST, no treasure (0 point) is obtained after T=20 times of actions, and thus it is assumed that Nadir={0, −20}. Even when the number of indicators Y is three or more, the hypervolume can be calculated using the Walking Fish Group based algorithm. A series of processing according to the above Formula (2) is executed by, for example, the hypervolume calculation circuit 207.

### Step S610

Returning to FIG. 6, the learning device 200 sets the Pareto solution set P(t+1)=P(t) when the contribution degree E(t) is 0 or less. On the other hand, when the contribution degree E(t) is greater than 0, the Pareto solution 901 indicating the cumulative reward Rsum(t) is combined with the Pareto solution set P(t) to obtain a Pareto solution set P′={Rsum(t)}∪P(t).

For example, in FIG. 9, in a case in which Pareto solutions b(1), b(2), and b(3) indicated by points 902 to 904 are present, when the Pareto solution 901 indicating the cumulative reward Rsum(t) is newly added, the hypervolume (a gray area portion when there are two indicators) increases, and the contribution degree E(t)>0 is satisfied.

A solution as a non-Pareto solution may be present by adding the cumulative reward Rsum(t) as a new Pareto solution 901 to the Pareto solution set P′. Therefore, the learning device 200 calculates, using the following Formula (3), presence or absence of contribution e(t) of solutions b(1), b(2), . . . , and b(k+1) (b(1) is present at minimum, and there are (K+1) solutions at maximum) in the Pareto solution set P′ to the hypervolume.

$$e ( t ) = min ( 0 , H ( - \{ {P}^{′} \backslash \{ b ( t ) \} \} ) ) - H ( - {P}^{′} ) \qquad ( 3 )$$

P′\{b (t)} means that a point b (t) is excluded from the Pareto solution set P′. When the hypervolume increases due to presence of the solution b(t) in the Pareto solution set P′, the above Formula (3) outputs a positive value. All of points whose values are 0 in e(1), e(2), . . . , and e(k) are excluded from the Pareto solution set P′, and the Pareto solution set P(t+1)=P′. In FIG. 9, b(2) indicating a Pareto solution 903 is excluded from the Pareto solution set P′ by adding the Pareto solution 901 indicating the cumulative reward Rsum(t).

In the reinforcement learning, when there is a single indicator, R(t) itself may be used as the reward, but when there are a plurality of indicators, setting of the reward is not obvious. As in NPL 1, it is necessary to select one indicator at each stage of learning and set the indicator as a reward, or to merge a plurality of indicators into one reward using any method.

In the first embodiment, instead of the reward R(t) output from the environment execution unit 303, the contribution degree E(t), which is an increased amount of the hypervolume, is set as the reward in the reinforcement learning. The output 704 of the Q network 302 is a function for predicting the contribution degree E(t) which is a cumulative increase amount of the hypervolume after step t when the action A(t) is executed, and learning of the Q network 302 proceeds in a manner of outputting the action A(t) that always leads to an increase in the hypervolume. The number of indicators is not limited, and the Q network 302 learns the strategy for reaching points each corresponding to a Pareto solution as long as the hypervolume can be calculated.

The strategy is generally expressed as a probability value π(A(t)|S(t)) for selecting the action A(t) in a certain state S(t). In the present embodiment, it is a strategy that the action A(t) in a certain state S(t) is determined by the network 799 (maximum value function 733) with a probability of 1. That is, it should be noted that the strategy is determined by the learning parameter θ 320 of the Q network 302.

### Step S611

The learning device 200 stores the training data 310 (S(t), P(t), A(t), R(t), S(t+1), P(t+1), Terminal(t+1)) in the replay memory 304. When the processing up to this point is described using the training data generation unit 300 in FIG. 3, it can be seen that, in steps S605 to S610, the training data 310 is generated by the Q network 302 and the environment execution unit 303 and stored in the replay memory 304.

### Step S612

As illustrated in FIG. 4, the learning device 200 randomly acquires B (B=64 in the first embodiment as an example) batches 410 (S(j), P(j), A(j), R(j), S(j+1), P(j+1), Terminal (j+1)) from the replay memory 304.

### Step S613

The learning device 200 calculates the target value y(j) using the following Formulas (4) and (5).

$$y ( j ) = \{ \begin{matrix}E ( j ) , if Terminal ( j + 1 ) = 1 & ( 4 ) \\ E ( j ) + γ {max}_{A} {Q}^{*} ( S ( j + 1 ) , P ( j + 1 ) , A ( j + 1 ) ) , & \\ otherwise & ( 5 )\end{matrix}$$

In the above Formula (5), Y in a second term on a right side is a discount coefficient, and y=0.98 in the first embodiment. A term excluding y among the second term on the right side is the output 704 obtained by inputting the state S (j+1) and the Pareto solution set P (j+1) to the Q* network 402.

### Step S614

The learning device 200 calculates the learning parameter θ 320 of the Q network 302 by applying a predicted value Q(S(j), P(j), A(j)) of the Q network 302 to the gradient method using the following Formula (6).

$$θ = θ + α {{grad}_{θ} ( y ( j ) - Q ( S ( j ) , P ( j ) , A ( j ) ) )}^{2} \qquad ( 6 )$$

In the above Formula (6), a is a learning coefficient, and α=0.001 is adopted in the first embodiment. In addition, grade is a gradient calculated in relation to θ. In a case in which the network 799 is formed using general deep-learning numerical value calculation software, when instructed to perform a calculation using the following Formula (7), the learning device 200 automatically executes update processing on the learning parameter θ 320. The calculation processing according to the above Formula (6) is executed by a learning processing unit 403.

$${( y ( j ) - Q ( S ( j ) , P ( j ) , A ( j ) ) )}^{2} \qquad ( 7 )$$

### Step S615

When the terminal signal Terminal (t+1) is 1 or t=T, the process proceeds to step S616. When neither the terminal signal Terminal (t+1) is 1 nor t=T, step t is incremented as (t=t+1) and the process returns to step S605.

### Step S616

The learning device 200 copies the learning parameter θ 320 of the Q network 302 into the learning parameter θ* 420 of the Q* network 402 for each number of steps C (C=5 in the first embodiment as an example). The learning device 200 draws the current search status 530 of the Pareto solution in the drawing region 506 of the GUI screen 500. Steps S602 to S616 are executed by the batch learning unit 400.

### Step S617

When the number of times of optimization (the number of episodes) M does not satisfy m=M, m is incremented as (m=m+1), and the process returns to step S602. When m=M, the process proceeds to step S618.

### Step S618

The learning device 200 draws the Pareto solution set P(t+1) in the environment 301 in the drawing region 506, and stores the Pareto solution set P(t+1), together with the learning parameter θ 320 of the Q network 302, in the storage device 202.

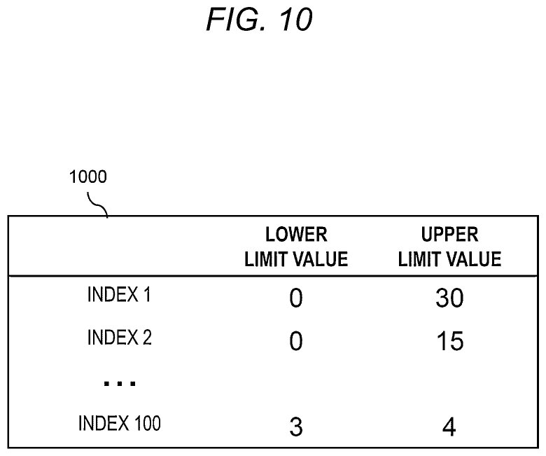

FIG. 10 is a diagram illustrating a first example of the Pareto solution set P(t+1) in an output format. Table data 1000 illustrates the Pareto solution set P(t+1) when the number of indicators Y=100.

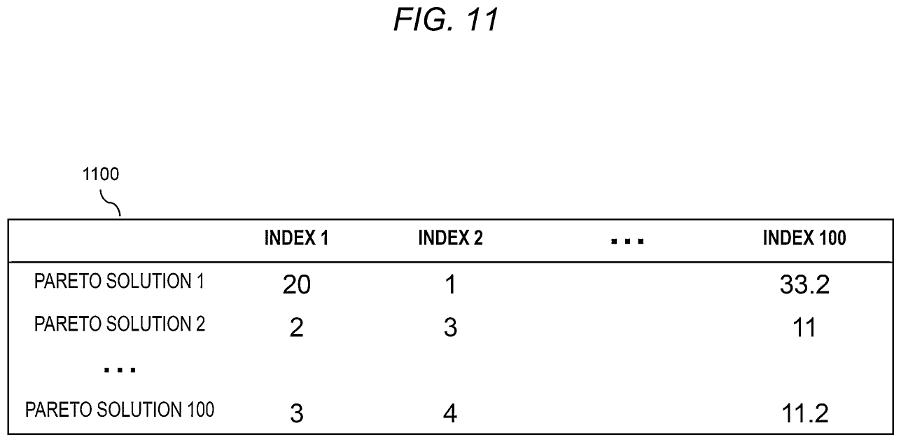

FIG. 11 is a diagram illustrating a second example of the Pareto solution set P(t+1) in the output format. Table data 1100 illustrates the Pareto solution set P(t+1) when the number of indicators Y=100 and when the Pareto solution is set such that the number of Pareto solutions K=100. The table data 1000 and 1100 can be displayed on a display as an example of the output device 204.

By the above processing, the learning parameter θ 320 of the Q network 302 that executes an action in accordance with conditions of the Pareto solution that are set by the user is output. The user can provide a player serving as the AI that operates the environment 301 with the Q network 302 that acts in accordance with the conditions of the Pareto solution.

### Experimental Results

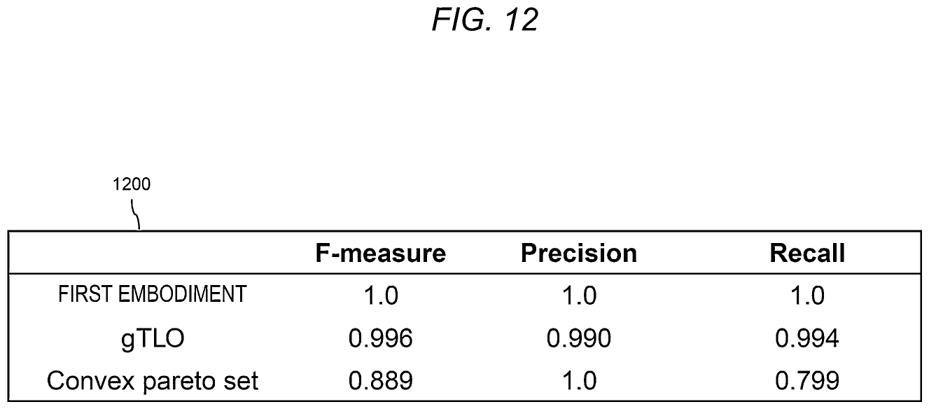

FIG. 12 is a table illustrating experimental results according to the first embodiment. When the hypervolume of an estimated Pareto solution is set as S and the hypervolume of a true Pareto solution is set as T, performance is evaluated using Precision=S∩T/S, Recall=S∩T/T, and f-measure=2(S×T)/(S+T). The number of trials is 10.

In the first embodiment, in table 1200, the hypervolume converges at a stage at which the average number of episodes is 500,000 times, f-measure, precision, and recall are all 1.0, and a strategy for reaching a true Pareto solution is learned. As a comparison method, experimental values of a method called gTLO (Table I) illustrated in NPL 4 are listed. In addition, values when a true Pareto solution is limited to a convex set (Convex pareto set) are listed as reference values.

The table 1200 illustrates that a measure capable of acquiring a non-convex Pareto solution set can be learned according to the first embodiment. As compared with the gTLO as a method in the related art, all Pareto solutions can be acquired with the same number of episodes. In addition, f-measure of gTLO is 0.98, and the number of acquired Pareto solutions at that time can be achieved at about 4/10.

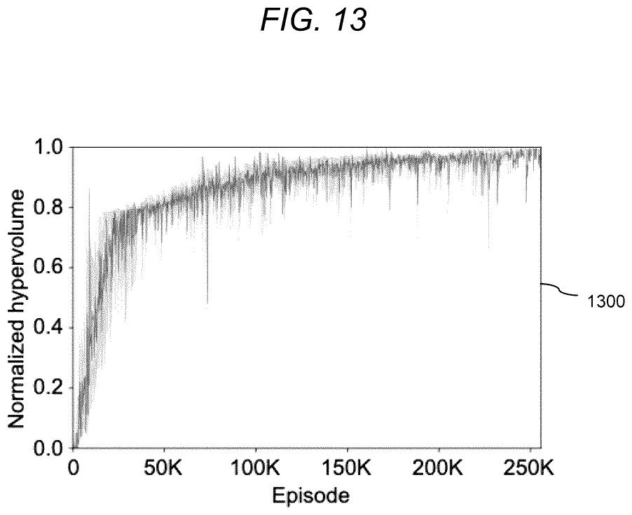

FIG. 13 is a graph illustrating a transition of the hypervolume according to the first embodiment. A vertical axis in a graph 1300 represents a size of a normalized hypervolume at a maximum value obtained from a true value. Arrangement of the horizontal axis is the number of episodes M (the number of times of learning). Although there is concern that it is difficult to directly approximate the hypervolume using the Q function 302, when the graph 1300 is observed, about 80% of the hypervolume is acquired with the number of episodes of about 25K, and then the hypervolume gently converges.

### Second Embodiment

Next, a second embodiment will be described. The second embodiment is an example in which only Pareto solutions under specific conditions are acquired. In the second embodiment, differences from the first embodiment will be mainly described, and thus description of the same parts as those in the first embodiment will be omitted. The same components as those in the first embodiment are denoted by the same reference numerals.

### Hypervolume Calculation Processing

A detailed process procedure of hypervolume calculation processing executed by the learning device 200 according to the second embodiment will be described. Before the execution, a graphical user interface (GUI) screen is displayed on the output device 204.

The output device 204 displays the GUI screen 500 illustrated in FIG. 5. In the learning device 200, by user operations, the number of Pareto solutions K is set in the first setting region 501, a range of scores is set in the second setting region 502, a range of action time is set in the third setting region 503, and the number of times of optimization (the number of episodes M) is set in the fourth setting region 504, and processing is started by clicking the execution start button 505.

The learning device 200 may set the range of scores and the range of action time by setting the target region 521 using the drawing tool 520 through user operations. In a game other than the DST, when a Pareto solution in which the number of indicators Y=3 or more is learned, the table data 1000 stores a target region of each indicator in a form of [upper limit value, lower limit value] in the storage device 202 as illustrated in FIG. 10.

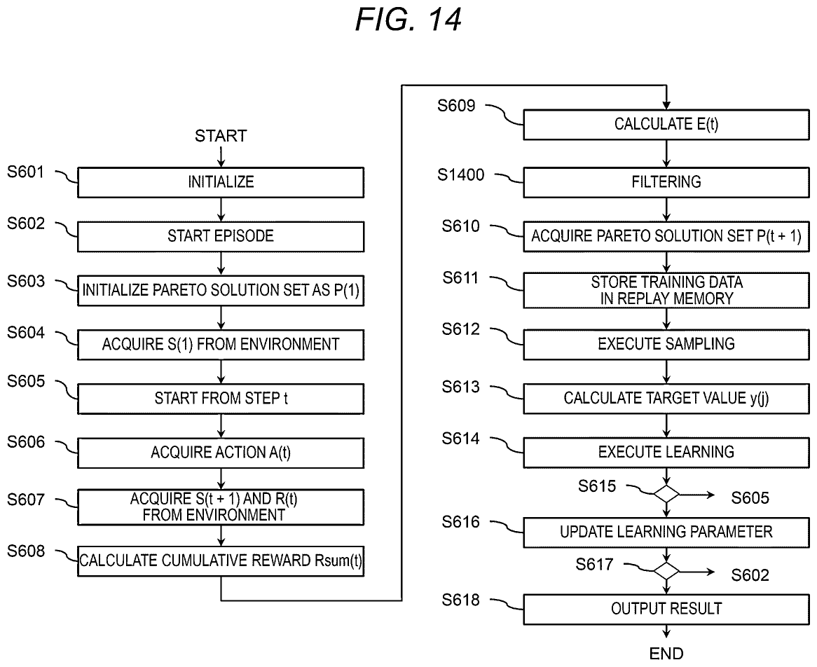

FIG. 14 is a flowchart illustrating an example of a detailed process procedure for training data generation and batch learning that are executed by the learning device 200 according to the second embodiment. When the execution start button 505 is pressed, the process illustrated in FIG. 14 is started. The learning device 200 executes steps S601 to S609 as in the first embodiment.

### Step S1400

After step S609, when the cumulative reward Rsum(t) is not present in the target region 521, the learning device 200 sets that the contribution degree E(t)=0. That is, in a subsequent step S610, the cumulative reward Rsum(t) is excluded from candidates of the Pareto solution. Thereafter, steps S610 to S618 are executed as in the first embodiment. In this manner, the learning parameter θ 320 of the Q network 302 that acts along the target region 521 in accordance with the conditions of the Pareto solution that are set by the user is output. The user can provide a player serving as an AI that operates in the state S with the Q network 302 in accordance with the conditions of the Pareto solution.

As described above, according to the present embodiment, it is possible to acquire a Pareto solution based on a plurality of indicators, and to provide an artificial intelligence that learns a strategy for reaching various Pareto solutions similarly to a human expert player. For example, it is helpful for a person to search for a better operation in a wide range of applications from a video game to a simulation environment in which a medical surgery is simulated.

The learning device 200 according to the first embodiment and the second embodiment described above may also have a configuration as in the following (1) to (9).

(1) The learning device 200 has a circuit configuration for learning a strategy in the environment 301 in which an action of performing an operation as time elapses is simulated and in which a value in the indicator space 510 defined by a plurality of indicators is given as a Pareto solution with respect to a result associated with the action. The plurality of indicators at least include an indicator related to the elapsed time (action time) and an indicator related to an execution result of the environment (score). The circuit configuration executes input processing (steps S603 and S604) of inputting a first Pareto solution set P(t) in which at least a non-Pareto solution remains when the environment 301 is executed until a first step t indicating a time point of the elapsed time, and a first state S(t) of the environment 301 in the first step t, selection processing (step S606) of selecting an action A(t) in the first state S(t) from the environment 301 by providing the environment 301 with the first Pareto solution set P(t) and the first state S(t), acquisition processing (step S607) of acquiring a reward R(t) related to the plurality of indicators in the first step t obtained as a result of the environment 301 selecting the action A(t), and a second state S(t+1) of the environment 301 in a second step (t+1) that is a step subsequent to the first step t due to the environment 301 taking the action A(t), calculation processing (step S609) of calculating, based on a cumulative reward Rsum(t) which is a cumulative value of rewards R(1) to R(t) up to the first step t and the first Pareto solution set P(t), a contribution degree E(t) which is a cumulative increase amount of a hypervolume since the first step t obtained as the result of the environment 301 selecting the action A(t), and update processing (step S610) of updating a second Pareto solution set P(t+1) in the second step (t+1) by adding the cumulative reward Rsum(t) to the first Pareto solution set P(t) as the Pareto solution based on the contribution degree E(t).

(2) In the learning device 200 according to the above (1), the circuit configuration executes output processing of outputting the second Pareto solution set P(t+1) obtained by the update processing.

(3) In the learning device 200 according to the above (2), in the output processing, the circuit configuration outputs an output order of the Pareto solution included in the second Pareto solution set in the indicator space 510 in a displayable manner.

(4) In the learning device 200 according to the above (2), the circuit configuration executes setting processing (FIG. 5) of setting a target region of the Pareto solution in the indicator space 510, and in the output processing, the circuit configuration outputs the second Pareto solution set and the target region in a displayable manner.

(5) In the learning device 200 according to the above (1), the circuit configuration executes setting processing (FIG. 5) of setting a target region of the Pareto solution in the indicator space 510, and in the calculation processing, the circuit configuration sets the contribution degree to a value excluding the cumulative reward Rsum(t) from the first Pareto solution set P(t) when the cumulative reward Rsum(t) is a value outside the target region (step S1400).

(6) In the learning device 200 according to the above (1), in the calculation processing, the circuit configuration calculates the cumulative increase amount using the Q function 302 (FIG. 7).

(7) In the learning device 200 according to the above (6), the Q function 302 is configured as a plurality of neural networks, and the plurality of neural networks include a featured network that executes processing of converting the first state into a vector, a set function network that executes processing of converting the first Pareto solution set P(t) into a vector, and a value network that receives output from the featured network and output from the set function network and outputs the action A(t) (FIG. 7).

(8) In the learning device 200 according to the above (6), the circuit configuration executes learning processing of calculating the learning parameter θ 320 of the Q function 302 based on a target value y(j) calculated by the Q* function 402 based on at least a contribution degree E (j) in a third step j among the contribution degree E (j) in the third step j, and a state S(j+1), a Pareto solution set P(j+1), and an action A(j+1) in a fourth step (j+1) different from the third step, and a predicted values Q (S (j), P(j), A(j)) calculated by the Q function 302 based on a state S (j), a Pareto solution set P(j), and an action A (j) in the third step j (Formula 6).

(9) In the learning device 200 according to the above (1), in the calculation processing, the circuit configuration calculates a first hypervolume (an area surrounded by b(0), b(1), b(2), and b (3)) based on the first Pareto solution set P(t), calculates a second hypervolume (an area 930 surrounded by b(0), b(1), the cumulative reward Rsum(t) (denoted by 901), and b(3)) based on the first Pareto solution set P(t) and the cumulative reward Rsum(t), and calculates the contribution degree E(t) based on a difference between the first hypervolume and the second hypervolume.

The invention is not limited to the above-described embodiments, and includes various modifications and equivalent configurations within the scope of the appended claims. For example, the above-described embodiments are described in detail for easy understanding of the invention, and the invention is not necessarily limited to those including all the configurations described above. A part of a configuration according to one embodiment can be replaced with a configuration according to another embodiment. A configuration according to one embodiment can also be added to a configuration according to another embodiment. A part of a configuration according to each embodiment may also be added, deleted, or replaced with another configuration.

A part or all of the above-described configurations, functions, processing units, processing methods, and the like may be implemented by hardware by, for example, designing with an integrated circuit, or may be implemented by software by, for example, a processor interpreting and executing a program for implementing each function.

Information on such as a program, a table, and a file for implementing each of the functions can be stored in a storage device such as a memory, a hard disk, or a solid state drive (SSD), or in a recording medium such as an integrated circuit (IC) card, an SD card, or a digital versatile disc (DVD).

Control lines and information lines considered to be necessary for description are illustrated, and all control lines and information lines for implementation are not necessarily illustrated. Actually, it may be considered that almost all the configurations are connected to each other.

What is claimed is:

1. A learning device comprising:
a circuit configuration configured to learn a strategy in an environment in which an action of performing an operation as time elapses is simulated and in which a value in an indicator space defined by a plurality of indicators is given as a Pareto solution with respect to a result associated with the action, wherein
the plurality of indicators at least include an indicator related to the elapsed time and an indicator related to an execution result of the environment, and
the circuit configuration executes
input processing of inputting a first Pareto solution set in which at least a non-Pareto solution remains when the environment is executed until a first step indicating a time point of the elapsed time, and a first state of the environment in the first step,
selection processing of selecting an action in the first state from the environment by providing the environment with the first Pareto solution set and the first state,
acquisition processing of acquiring a reward related to the plurality of indicators in the first step obtained as a result of the environment selecting the action, and a second state of the environment in a second step that is a step subsequent to the first step due to the environment taking the action,
calculation processing of calculating, based on a cumulative reward which is a cumulative value of rewards up to the first step and the first Pareto solution set, a contribution degree which is a cumulative increase amount of a hypervolume since the first step obtained as the result of the environment selecting the action, and
update processing of updating a second Pareto solution set in the second step by adding the cumulative reward to the first Pareto solution set as the Pareto solution based on the contribution degree.

2. The learning device according to claim 1, wherein
the circuit configuration executes output processing of outputting the second Pareto solution set obtained by the update processing.

3. The learning device according to claim 2, wherein
in the output processing, the circuit configuration outputs an output order of the Pareto solution included in the second Pareto solution set in the indicator space in a displayable manner.

4. The learning device according to claim 2, wherein
the circuit configuration executes setting processing of setting a target region of the Pareto solution in the indicator space, and
in the output processing, the circuit configuration outputs the second Pareto solution set and the target region in a displayable manner.

5. The learning device according to claim 1, wherein
the circuit configuration executes setting processing of setting a target region of the Pareto solution in the indicator space, and
in the calculation processing, the circuit configuration sets the contribution degree to a value excluding the cumulative reward from the first Pareto solution set when the cumulative reward is a value outside the target region.

6. The learning device according to claim 1, wherein
in the calculation processing, the circuit configuration calculates the cumulative increase amount using a Q function.

7. The learning device according to claim 6, wherein
the Q function is configured as a plurality of neural networks, and the plurality of neural networks include a featured network configured to execute processing of converting the first state into a vector, a set function network configured to execute processing of converting the first Pareto solution set into a vector, and a value network configured to receive output from the featured network and output from the set function network and output the action.

8. The learning device according to claim 6, wherein
the circuit configuration executes learning processing of calculating a learning parameter of the Q function based on a target value calculated by the Q function based on at least a contribution degree in a third step among the contribution degree in the third step, and a state, a Pareto solution set, and an action in a fourth step different from the third step, and a predicted value calculated by the Q function based on a state, a Pareto solution set, and an action in the third step.

9. The learning device according to claim 1, wherein
in the calculation processing, the circuit configuration calculates a first hypervolume based on the first Pareto solution set, calculates a second hypervolume based on the first Pareto solution set and the cumulative reward, and calculates the contribution degree based on a difference between the first hypervolume and the second hypervolume.

10. A learning method executed by a learning device,
the learning device including a circuit configuration configured to learn a strategy in an environment in which an action of performing an operation as time elapses is simulated and in which a value in an indicator space defined by a plurality of indicators is given as a Pareto solution with respect to a result associated with the action,
the plurality of indicators at least including an indicator related to the elapsed time and an indicator related to an execution result of the environment,
the learning method comprising:
by the circuit configuration,
input processing of inputting a first Pareto solution set in which at least a non-Pareto solution remains when the environment is executed until a first step indicating a time point of the elapsed time, and a first state of the environment in the first step;
selection processing of selecting an action in the first state from the environment by providing the environment with the first Pareto solution set and the first state;
acquisition processing of acquiring a reward related to the plurality of indicators in the first step obtained as a result of the environment selecting the action, and a second state of the environment in a second step that is a step subsequent to the first step due to the environment taking the action;
calculation processing of calculating, based on a cumulative reward which is a cumulative value of rewards up to the first step and the first Pareto solution set, a contribution degree which is a cumulative increase amount of a hypervolume since the first step obtained as the result of the environment selecting the action; and
update processing of updating a second Pareto solution set in the second step by adding the cumulative reward to the first Pareto solution set as the Pareto solution based on the contribution degree.

11. A learning program for causing a processor of a learning device to execute processing, the learning device learning a strategy in an environment in which an action of performing an operation as time elapses is simulated and in which a value in an indicator space defined by a plurality of indicators is given as a Pareto solution with respect to a result associated with the action, wherein
the plurality of indicators at least include an indicator related to the elapsed time and an indicator related to an execution result of the environment, and
the processor is caused to execute
input processing of inputting a first Pareto solution set in which at least a non-Pareto solution remains when the environment is executed until a first step indicating a time point of the elapsed time, and a first state of the environment in the first step,
selection processing of selecting an action in the first state from the environment by providing the environment with the first Pareto solution set and the first state,
acquisition processing of acquiring a reward related to the plurality of indicators in the first step obtained as a result of the environment selecting the action, and a second state of the environment in a second step that is a step subsequent to the first step due to the environment taking the action,
calculation processing of calculating, based on a cumulative reward which is a cumulative value of rewards up to the first step and the first Pareto solution set, a contribution degree which is a cumulative increase amount of a hypervolume since the first step obtained as the result of the environment selecting the action, and
update processing of updating a second Pareto solution set in the second step by adding the cumulative reward to the first Pareto solution set as the Pareto solution based on the contribution degree.
